(19) United States
(12) Patent Application Publication
(10) Pub. No.: US 2025/0297875 A1
(43) Pub. Date: Sep. 25, 2025

(54) Measuring the flow rate of fluids

(71) Applicant: SICK AG, Waldkirch (DE)

(72) Inventors: Jens ALBRECHT, Waldkirch (DE); William WEIGOLD, Waldkirch (DE)

(21) Appl. No.: 19/077,583

(22) Filed: Mar. 12, 2025

(30) Foreign Application Priority Data
Mar. 20, 2024 (DE) 102024107897.9

(51) Int. Cl. G01F 1/667; G01F 1/66

(52) U.S. Cl. CPC G01F 1/667; G01F 1/662

(57) ABSTRACT

A method of measuring the flow rate of a fluid includes a first ultrasonic signal being transmitted and received with the flow and a second ultrasonic signal being transmitted and received against the flow on a measurement path obliquely to a direction of flow of the fluid. A first time of flight of the first ultrasonic signal and a second time of flight of the second ultrasonic signal are determined and the flow rate is determined from a time of flight difference. The ultrasonic signals have a plurality of periods of a carrier frequency having an amplitude modulated in accordance with an envelope and a respective reception point in time of an ultrasonic signal is fixed from a selected oscillation of the ultrasonic signal that is selected with reference to the progression of the envelope for the determination of the times of flight.

The invention relates to a method and to an ultrasound measuring device for measuring the flow rate of a fluid respectively.

Flow rates in pipes and passages can be determined by means of ultrasound measurement technology in accordance with the time of flight difference method. In this respect, ultrasonic signals are transmitted and received by a pair of ultrasonic transducers that are arranged mutually opposite at a wall of the pipe at the ends of a measurement path obliquely to the flow of the fluid. The flow rate is determined from the time of flight difference of the ultrasound on the measurement path with the flow and in the opposite direction against the flow. The ultrasonic transducers work alternately as transmitters and receivers here. The ultrasonic signals transported through the fluid are accelerated in the direction of flow and are decelerated against the direction of flow. The resulting time of flight difference is calculated using geometrical parameters to form a mean speed of the fluid. Together with the cross-sectional area, the operating volume flow results from this which is frequently the measurement variable of actual interest with a fluid billed by volume. Additional measurement paths with further ultrasonic transducers can also be provided for a higher measurement accuracy.

One difficulty in the determination of the times of flight is the temporal localization of the ultrasonic signals. Conventionally, pulse packets or chirps are used as ultrasonic signals, that is a plurality of oscillations in the carrier frequency of the ultrasound whose amplitudes are modulated in accordance with an envelope of, for example, a bell shape. The maximum of the envelope would not be precise enough, but can be used as an orientation to localize a specific oscillation of the ultrasonic signal. The reception point in time is then determined, for example, from the zero crossing of this selected oscillation. It is problematic in this procedure that the maximum of the envelope is not even precise and stable enough for the comparatively coarse temporal orientation for selecting a specific oscillation of the ultrasonic signal. This applies above all on changed conditions in the operation of the ultrasound measuring device, for instance due to temperature fluctuations of the fluid, aging of the ultrasonic transducers, scattered objects in the fluid such as bubbles or solids, and a change to a different, uncalibrated fluid. The envelope changes with such drifts and a different oscillation is therefore possibly selected. This measurement error is called a phase jump because the reception point in time so-to-say jumps into a different oscillation.

US 2007/0191990 A1 describes a flow rate measurement comprising a bubble recognition to optionally be able to output a warning or to freeze output values until the bubble has disappeared again. One criterion for the presence of a bubble is a change in the amplitudes, another one is the difference from times of flight at a point in time t and a point in time t−1.

An ultrasound measuring unit is presented in U.S. Pat. No. 6,950,768 B2 that recognizes and corrects time of flight errors by different diagnoses.

U.S. Pat. No. 6,941,821 B2 deals with an ultrasound flow rate measuring unit that dynamically sets the number of measurement repeats.

It is therefore the object of the invention to further improve the measurement of the flow rate in a time of flight difference method with an ultrasonic transducer.

This object is satisfied by a method and an ultrasound measuring device for measuring the flow rate of a fluid in accordance with the respective independent claim. In accordance with the ultrasound time of flight difference method already briefly explained in the introduction, a first ultrasonic signal is transmitted and received with the flow and a second ultrasonic signal is transmitted and received against the flow on a slanted measurement path, i.e. on a measurement path having at least one component in the direction of flow and one against the direction of flow, to determine a first time of flight and a second time of flight. The flow rate is determined from the time of flight difference of the two times of flight, that is with and against the flow. The ultrasonic signals each have a plurality of periods of a carrier frequency, with the amplitude being modulated in accordance with an envelope. An oscillation or a portion of an oscillation of the ultrasonic signal is selected and thus the reception point in time required for determining the times of flight is determined using the progression of the envelope in the received ultrasonic signal, in particular a characteristic such as its maximum, the focus, or the like.

The invention starts from the basic idea of recognizing incorrect measurements on the basis of phase jumps from sudden changes in the first time of flight or the second time of flight. A phase jump means that a different oscillation is selected, for example because the envelope is deformed due to drift effects, in particular due to dispersion. The time of flight difference then has an error to the amount of a multiple of the period of the carrier frequency. To reveal this, a first difference of the first time of flight from a previously determined, that is earlier, first time of flight and/or a second difference of the second time of flight from a previously determined, that is earlier, second time of flight is calculated. A check is made whether the first difference and/or the second difference amount/amounts to a multiple of the period of the carrier frequency, with a tolerance being permitted. If this is the case, the first time of flight and/or the second time of flight is/are corrected by this multiple of the period of the carrier frequency. A phase jump is therefore assumed due to the coincidence with a multiple of the period of the carrier frequency and it is corrected or reversed by calculation. In this respect, the term of difference is overloaded; the domains may not be confused. The time of flight difference from which the flow rate (also known as the flow velocity) is determined is a difference of two different times of flight with and against the flow. In contrast, the first difference and the second difference are temporal differences or discrete derivations within the first time of flight or within the second time of flight.

The invention has the advantage that the impairment of the measurement of the flow rate by phase jumps is very largely canceled. The correction takes account of phase jumps in both temporal directions, in both ultrasonic signals with the flow and against the flow, and also multi-valued phase jumps over more than one period of the carrier frequency. The measured value is thereby considerably more robust, more stable, and more accurate and an exact measurement is also possible after drifting or under difficult measurement conditions such as bubble formation or particles in the fluid.

The measurement is preferably repeated in sampling periods of a temporal resolution and the previously determined first time of flight and/or the previously determined second time of flight is/are used from a preceding sampling period, in particular from a directly preceding sampling period. A temporal granularity is thereby indicated to which the previously determined times of flight can be related, in particular in that the respective times of flight of the directly preceding sampling period are used as the previously determined times of flight for calculating the first difference or the second difference respectively. The measurement thus takes place quasi-continuously in a discrete temporal resolution corresponding to the sampling period. The sampling should not be confused with a digitizing of the ultrasonic signals that is again a lot finer for their digital evaluation. In a sampling period in the sense meant here, a respective value for the flow rate is determined by evaluation of respective, possibly previously digitized, ultrasonic signals. A sampling period should accordingly preferably be fine enough so that the flow remains quasi-constant on its time scale. Otherwise actual changes in the flow rate or speed of sound can be confused with phase jumps.

The tolerance preferably amounts to at most 20%, at most 15%, at most 10%, or at most 5% of a period. A phase jump will in reality not exactly result in a measurement error to the amount of a multiple of the period of the carrier frequency so that a certain tolerance is permitted. Some possible values for the tolerance are named here, with intermediate values or an even smaller tolerance less than 5% also being conceivable. Depending on the tolerance, there will be more errors of the first kind or of the second kind, that is changes incorrectly recognized as phase jumps that are really actual measurement effects or unrecognized phase jumps that are incorrectly interpreted as measurement effects.

The multiple preferably amounts to times one or times two of a period of the carrier frequency. In particular only the times one is corrected, that is one phase jump corrected by exactly one period of the carrier frequency. Even larger differences frequently have different causes than a phase jump, however, with at least the double of a period of the carrier frequency still being able to be a sensible criterion.

When the first time of flight and/or the second time of flight is/are corrected over a plurality of sampling periods, in particular two sampling periods to ten sampling periods, by the same multiple of the period of the carrier frequency, the correction is in particular reset. This is a plausibility criterion for phase jumps by which possible false corrections that are not due to a phase jump are reversed again. If the same correction appears necessary for a certain number of sampling periods, there is the risk that the evaluation only locks onto the false oscillation by the correction and thus artificially. The value for this number is a parameter that can be selected in the range from two to ten and beyond. The plausibility criterion can be related to one of the times of flight with the flow and against the flow or, particularly preferably, to both times of flight.

When a signal quality of the first ultrasonic signal and/or of the second ultrasonic signal is above a minimum signal quality during a correction, in particular for two sampling periods to ten sampling periods, the correction is in particular reset. This is a further plausibility criterion that can be used alternatively or accumulatively to the check of the correction history of the previous paragraph. There is again a parameter that fixes the length of the observed time interval that can be between two and ten or even more sampling periods. To evaluate the signal quality in sum over the observed time interval, a statistical measure such as the mean value or the median can be used. A high signal quality is an indication against a correction being necessary; a genuine measurement effect or an actual change of the flow rate or the speed of sound is then rather present. A possibly performed correction is therefore reset or reversed at a high signal quality under said conditions.

The signal quality is preferably calculated from a Fourier transform of the first ultrasonic signal and/or of the second ultrasonic signal in that a spectral portion of the carrier frequency is evaluated with respect to the other spectral portions. This is one possibility of setting the useful signal into a relationship with the noise and thus to evaluate a signal-to-noise quality. A spectral band of a fixed width is, for example, fixed around the carrier frequency and the integral of the Fourier transform in this spectral band is placed in relation to an integral over the remaining spectrum outside this spectral band. This value can then be compared with the minimum signal quality, with a norming optionally still being carried out.

The invention will be explained in more detail in the following also with respect to further features and advantages by way of example with reference to embodiments and to the enclosed drawing. The Figures of the drawing show in:

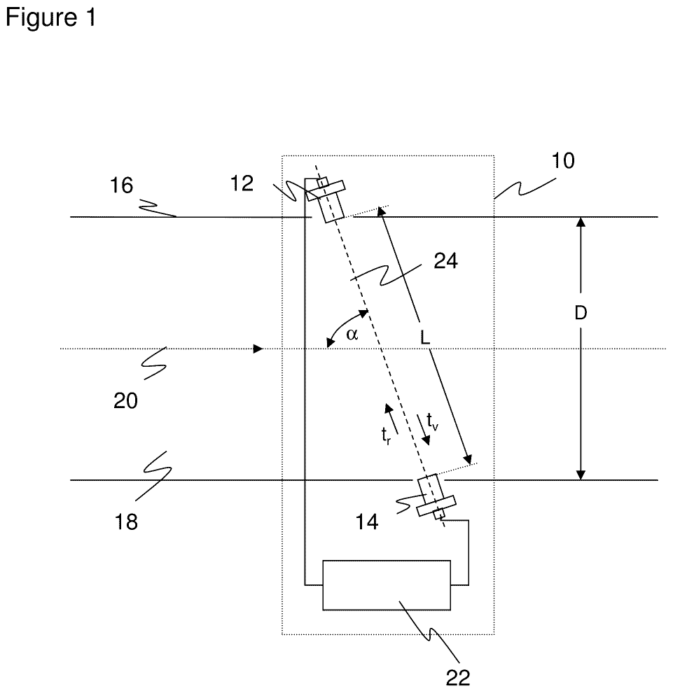

FIG. 1 a basic design of a time of flight based ultrasound measurement device with its measurement path and entered geometrical variables for the flow rate determination;

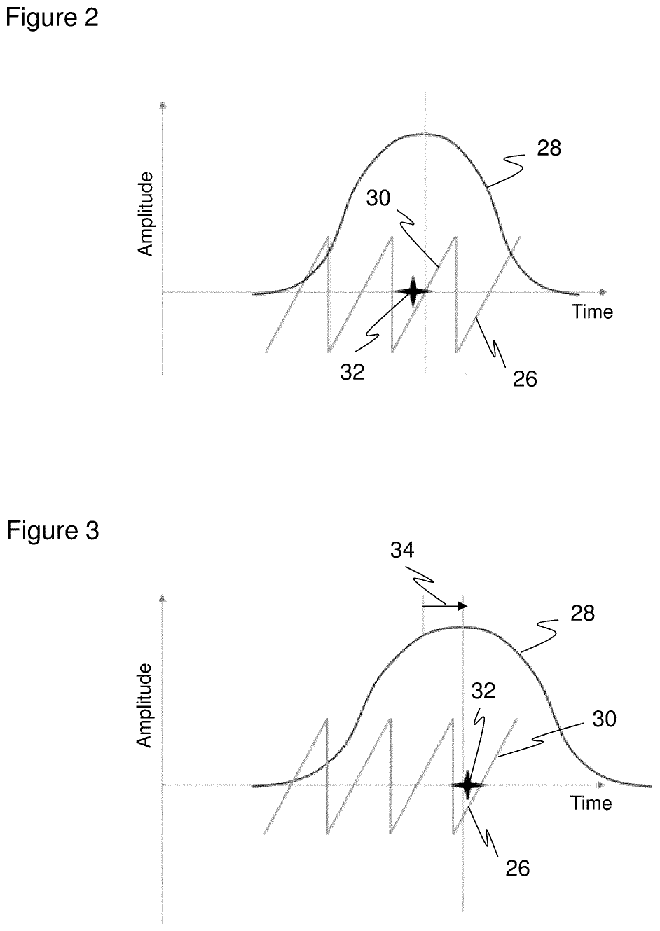

FIG. 2 a sketch of an ultrasonic signal to explain the selection of an oscillation for determining a reception point in time;

FIG. 3 a sketch similar to FIG. 2 in which a different oscillation has been incorrectly selected due to a dispersion effect;

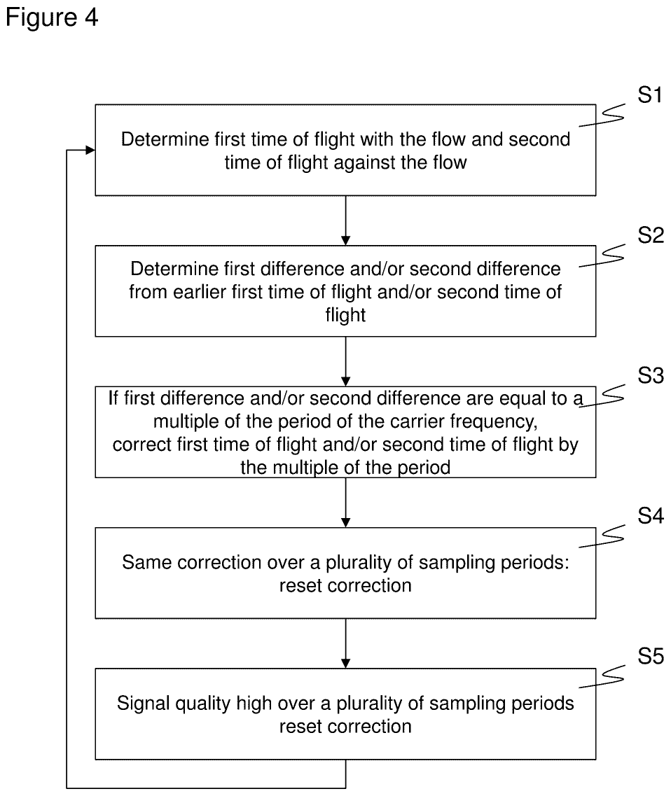

FIG. 4 an exemplary flowchart for the correction of times of flight on a phase jump with a check of the plausibility of the correction;

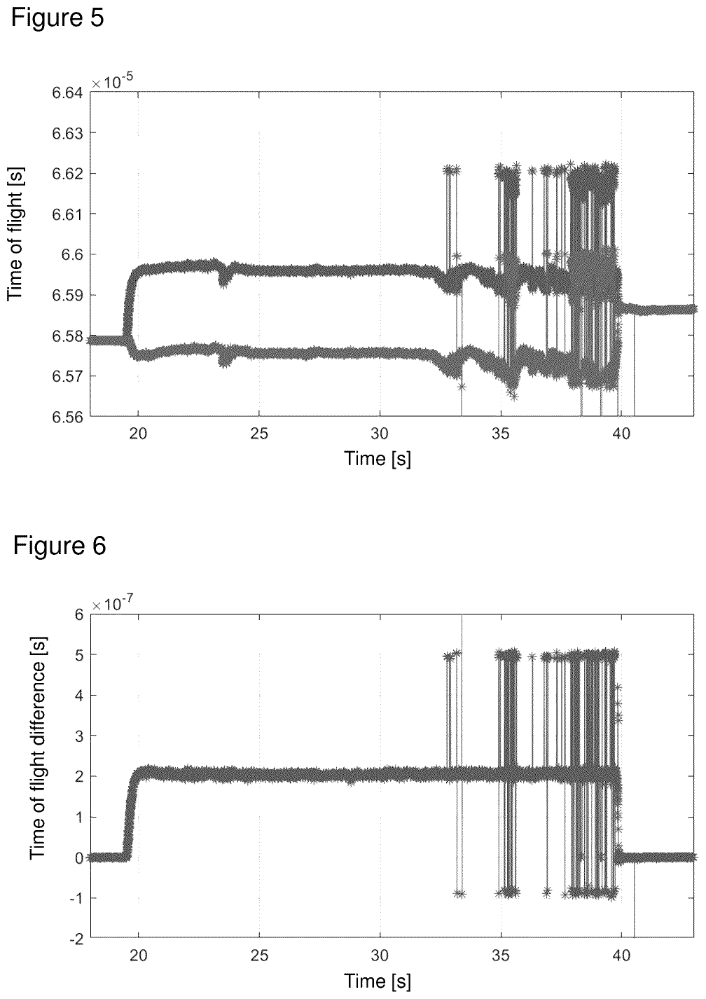

FIG. 5 exemplary measurement data for the temporal progression of a first time of flight with the flow and a second time of flight against the flow without a correction in accordance with the invention;

FIG. 6 time of flight differences between the first time of flight and the second time of flight calculated from the measurement data of FIG. 5;

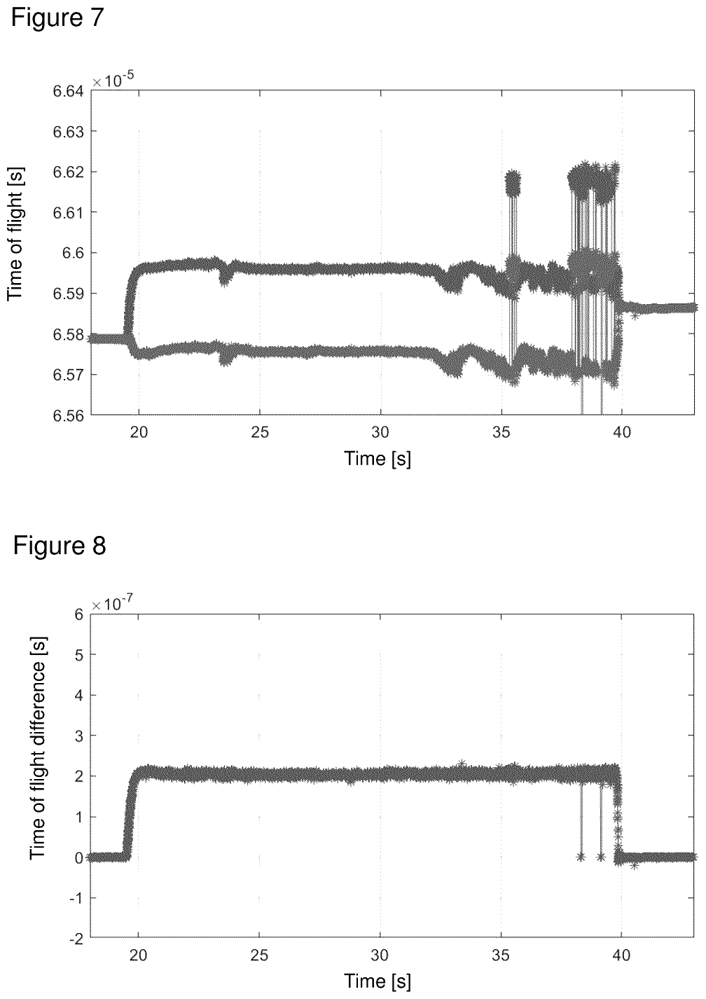

FIG. 7 exemplary measurement data similar to FIG. 5, but now with a correction in accordance with the invention;

FIG. 8 time of flight differences between the first time of flight and the second time of flight calculated from the measurement data of FIG. 7;

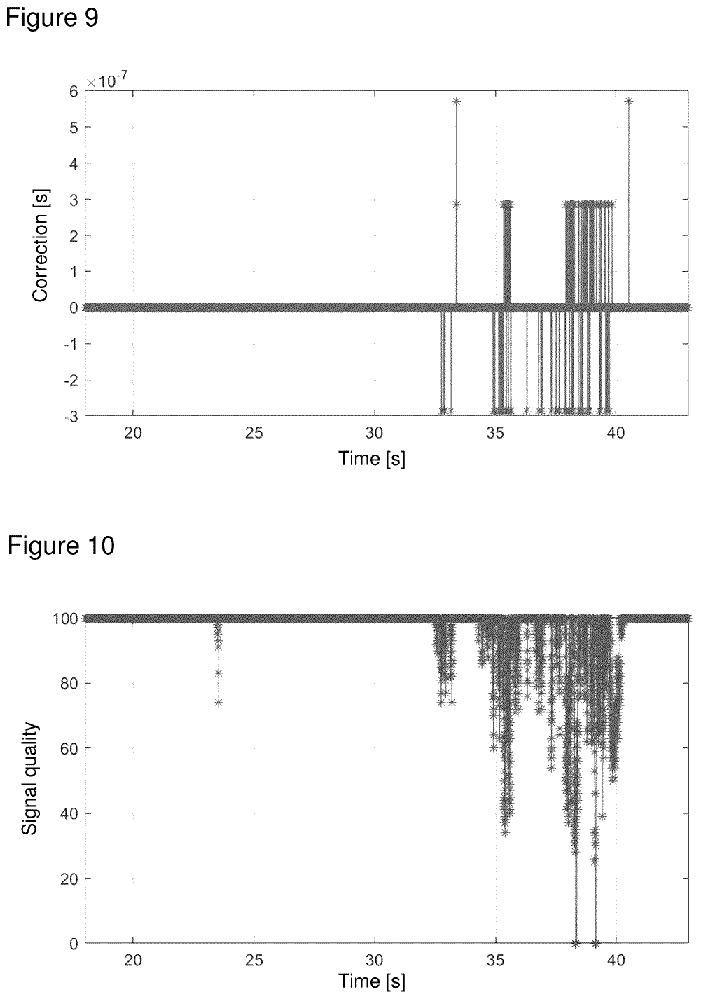

FIG. 9 a representation of the corrections performed for FIG. 7; and

FIG. 10 a representation of the signal quality with respect to the measurement data.

FIG. 1 shows a basic design of a time of flight based ultrasound measurement device 10. Two ultrasonic transducers 12, 13 are arranged at an angle α measured with respect to the perpendicular in the wall of a pipe 16 in which a fluid 18 flows in the direction of the arrow 20. The ultrasonic transducers 12, 14 work, controlled by a control and evaluation unit 22, alternately as transmitters and receivers. The ultrasound signals transported on a measurement path 24 by the fluid 18 are accelerated in the direction of flow and are braked against the direction of flow. The respective received signals are supplied to the control and evaluation unit 22 via circuit elements such as amplifiers and A/D converters and are digitally evaluated. For this purpose, the resulting time of flight difference in accordance with v=L/(2 cos α)(1/tᵥ−1/tᵣ) with respect to the sought flow rate or in accordance with Q=v ¼ D²π with respect to an operating volume flow is offset, with the geometrical relationships being described as in FIG. 1 by the following variables:
v: flow rate of the fluid in the line
L: length of the measurement path between the two ultrasonic transducers
α: angle at which the ultrasonic transducers transmit and receive
Q: volume flow
D: diameter of the line
tᵥ: time of flight of the ultrasound with the flow and
tᵣ: time of flight of the ultrasound against the flow.

The calculation in said variables is to be understood as an example; there are other possibilities of measuring the transit time difference and of determining the flow rate or the volume flow therefrom. The design of the ultrasonic transducers 12, 14 and the geometry of the measurement path, including the possibility of a plurality of measurement paths, can in particular be varied in a manner known per se. The control and evaluation 22 unit can be integrated in the ultrasound measurement device 10 or can be provided as an external device or as a mixed form of the two. At least a preferably digital processing module such as a microprocessor or a CPU (central processing unit), an FPGA (field programmable gate array), a DSP (digital signal processor), an ASIC (application specific integrated circuit), or the like is provided therein. An external processing unit can be a computer of any desired kind, including notebooks, smartphones, tablets, a dedicated controller, equally a local network, an edge device, or a cloud.

FIG. 2 shows a sketch of an ultrasonic signal used for the time of flight measurements. Chirps or pulse packages are respectively transmitted and received that comprise a plurality of oscillations in the carrier frequency of the ultrasound and whose amplitudes are modulated over the oscillations. In simple terms, the oscillations are only shown as saw teeth 26 of the same amplitudes with respect to one another; in reality, the oscillations nestle into the envelope 28 generated by the modulation of the amplitudes. An oscillation 30 is selected using the maximum of the envelope 28 and the reception point in time 32 is, for example, determined from its zero crossing. In alternative embodiments, at least one further adjacent oscillation can be added for the determination of the reception point in time 32.

FIG. 3 shows a sketch similar to FIG. 2 in which the envelope 28 is widened due to a dispersion effect, for example due temperature fluctuations, aging, or interfering objects such as bubbles or particles in the flow. The maximum of the envelope 28 is thereby displaced, as indicated by the arrow 34. This in turn has the consequence that a different oscillations 30 is now used to determine the reception point in time 32. The problematic result is a phase jump in the time of flight measurement, i.e. the time of flight has been extended by a period of the carrier frequency despite the flow rate being the same.

FIG. 4 shows an exemplary flowchart for the recognition of phase jumps and for a corresponding correction of times of flight. All the steps do not necessarily have to be caried out; the two final plausibility criteria are in particular optional. The times of flight are determined with the flow and against the flow in a step S1. In this respect, in particular as explained with respect to FIG. 1, ultrasonic signals are transmitted and received along the measurement path 24 in both directions. The respective reception point in time is determined, for example, as explained with respect to FIG. 2 and the times of flight thus result together with the known transmission point in time and a calibration for internal signal delays.

FIG. 5 shows exemplary measurement data for the temporal progression of a first time of flight with the flow (bottom) and a second time of flight against the flow (top). The times of flight are measured in sampling periods that, however, are preferably so close together that a progression is produced that is admittedly discrete, but is quasi-continuous for practical purposes. A large number of phase jumps can be recognized in the right part of FIG. 5; a correction in accordance with the invention has not taken place in FIG. 5. FIG. 6 shows the corresponding time of flight differences, that is the point-wise difference of the times of flight from FIG. 5 at respectively the same time. A large number of the phase jumps are transferred in the right part if the same phase jump does not randomly occur at the same time in both times of flight and the error is thereby canceled at one point in time.

Returning to FIG. 4, a first difference between a current first time of flight and an earlier first time of flight and/or a second difference between a current second time of flight and an earlier time of flight is/are determined in a step S2 to prepare the revealing of phase jumps. The difference from the preceding point in time t−1 is preferably determined at every point in time t. This is a discrete approximation to the temporal derivation of the measured times of flight; different approximations, for example using different preceding points in time, are alternatively conceivable. A check is then made whether the first and/or second difference is equal to a multiple of the period of the carrier frequency. If this condition applies, it is evaluated as a recognition of a phase jump since this is considerably more likely than a sudden change of the flow rate by just a multiple of the period of the carrier frequency. The silent assumption here is that the sampling periods for the measurement of times of flight are short enough and are therefore close enough in comparison with the changes of the flow rate or speed of sound that can be expected. The comparison preferably takes place with a certain tolerance, i.e. the first difference and/or the second difference is/rare considered as equal to a multiple of a period of the carrier frequency if it applies at an interval of ±x % of a period, where x=5, 10, 15, 20, or a comparable value. The multiple is preferably the times one since a simple phase jump is the most likely. In a preferred embodiment, the times two is also permitted; even greater multiples are conceivable, but hardly ever occur in practice. It must still be noted in summary with respect to the correction in accordance with step S3 that the measured times of flight are checked for plausibility here to reveal any phase error, namely for sudden changes in multiples of a period of the carrier frequency. This begins at a completely different point than conventional methods that desire a particularly exact determination of the reception point in time by additional knowledge on the environmental conditions, for example the speed of sound of the fluid or its temperature or by special evaluations or, for example, use ultrasonic transducers 12, 14 of a particularly high bandwidth to detect the envelope 28 and thus its temporal location more exactly. The fact that the invention proceeds differently does not, on the other hand, preclude using such measures to complement the invention.

FIG. 7 shows exemplary measurement data similar to FIG. 5, but now with a correction in accordance with the invention; It can already be recognized in the right part that a plurality of phase jumps were able to be corrected. This is, however, only a fraction of the positive effect. It is namely just as helpful as a correction of a phase jump if both times of flight are admittedly subject to a phase jump as long as it is the same phase jump. This is shown in FIG. 8 with the time of flight differences between the first time of flight and the second time of flight calculated from the corrected measurement data of FIG. 7. The phase jumps that are the same namely disappear in the time of flight difference so that no relevant phase jumps at all remain here overall except for two brief remaining outliers. FIG. 9 in addition shows a further representation of the corrections carried out for FIG. 7

Further plausibilization criteria are checked in the optional steps S4 and S5. These steps can be performed both together, individually, or not all depending on the embodiment. The further plausibilization criteria should prevent the evaluation settling on an incorrect oscillation due to the corrections. A check is made in step S4 whether the respective last two times of flight were corrected by the same multiple of the period of the carrier frequency. This can be done for the first time of flight and/or for the second time of flight and can go back, for example, to two, five, ten, or a similar number of sampling periods. Step S4 is based on the heuristics that a longer correction of the same kind no longer indicates a phase jump, bur rather a genuine measurement effect so that the correction is reset or reversed.

A signal quality is checked over a plurality of sampling periods in step S5 as a further possible plausibilization criterion; there can again be two, five, ten, or a comparable number of sampling periods. The signal quality is preferably consolidated with a statistical measure such as the mean value or the median over the considered sampling periods. FIG. 10 shows a representation of the signal quality with respect to the measurement data previously observed. In this example, the signal quality is calculated in that a Fourier transform is first carried out. A spectral band is fixed about the carrier frequency in the Fourier transform and the signal portion in this spectral band is put into relation with the signal portion in the remaining spectrum, with signal portions being determined by integration, for example. A norming preferably takes place so that the signal quality is within the interval 0-100%. The signal quality, in particular a signal-to-noise ratio, can, however, also be evaluated differently; different methods are known per se from signal processing for this purpose.

A high signal quality, for example set by a threshold such as 90%, 95%, 98%, 99%, 99.5%, indicates that a correction is not appropriate because it is presumably a genuine measurement effect so that the correction is reset at a high signal quality over the considered sampling periods. The plausibilization criteria of steps S4 and S5 can be combined. The correction is reset in an example for this purpose if identical corrections were made over ten sampling periods and a signal quality of on average more than 99% has been found at the same time.

1. A method of measuring the flow rate of a fluid in which a first ultrasonic signal is transmitted and received again with the flow and a second ultrasonic signal is transmitted and received again against the flow on a measurement path obliquely to a direction of flow of the fluid; a first time of flight of the first ultrasonic signal and a second time of flight of the second ultrasonic signal are determined and the flow rate is determined from a time of flight difference of the first time of flight and the second time of flight, wherein the ultrasonic signals have a plurality of periods of a carrier frequency having an amplitude modulated in accordance with an envelope; and a respective reception point in time of an ultrasonic signal is fixed from a selected oscillation of the ultrasonic signal that is selected with reference to a progression, in particular to a maximum, of the envelope for the determination of the times of flight,
wherein a first difference of the first time of flight and of a previously determined time of flight and/or a second difference of the second time of flight and of a previously determined second time of flight is/are calculated; and wherein if the first difference and/or the second difference amounts/amount to a multiple of the period of the carrier frequency, except for a tolerance, the first time of flight and/or the second time of flight is/are corrected by the multiple of the period of the carrier frequency.

2. The method in accordance with claim 1,
wherein the measurement is repeated in sampling periods of a temporal resolution and the previously determined first time of flight and/or the previously determined second time of flight is/are used from a preceding sampling period.

3. The method in accordance with claim 2,
wherein the previously determined first time of flight and/or the previously determined second time of flight is/are used from a directly preceding sampling period.

4. The method in accordance with claim 1,
wherein the tolerance amounts to at most 20%, at most 15%, at most 10%, or at most 5% of a period of the carrier frequency.

5. The method in accordance with claim 1,
wherein the multiple amounts to the times one or the times two of a period of the carrier frequency.

6. The method in accordance with claim 1,
wherein the correction is reset when the first time of flight and/or the second time of flight is/are corrected over a plurality of sampling periods by the same multiple of the period of the carrier frequency.

7. The method in accordance with claim 6,
wherein the correction is reset when the first time of flight and/or the second time of flight is/are corrected over two sampling periods to ten sampling periods.

8. The method in accordance with claim 1,
wherein the correction is reset when a signal quality of the first ultrasonic signal and/or of the second ultrasonic signal is above a minimum signal quality during a correction.

9. The method in accordance with claim 8,
wherein the correction is reset when a signal quality of the first ultrasonic signal and/or of the second ultrasonic signal is above a minimum signal quality during a correction for two sampling periods to ten scan periods.

10. The method in accordance with claim 8,
wherein the signal quality is calculated from a Fourier transform of the first ultrasonic signal and/or of the second ultrasonic signal in that a spectral portion of the carrier frequency is evaluated with respect to the other spectral portions.

11. An ultrasound measuring device for measuring the flow rate of a fluid having at least two ultrasonic transducers that are arranged facing one another and that span a measurement path extending obliquely to the flow through the fluid and having a control and evaluation unit that is configured to measure the flow rate using a method of measuring the flow rate of a fluid in which a first ultrasonic signal is transmitted and received again with the flow and a second ultrasonic signal is transmitted and received again against the flow on a measurement path obliquely to a direction of flow of the fluid; a first time of flight of the first ultrasonic signal and a second time of flight of the second ultrasonic signal are determined and the flow rate is determined from a time of flight difference of the first time of flight and the second time of flight, wherein the ultrasonic signals have a plurality of periods of a carrier frequency having an amplitude modulated in accordance with an envelope; and a respective reception point in time of an ultrasonic signal is fixed from a selected oscillation of the ultrasonic signal that is selected with reference to a progression, in particular to a maximum, of the envelope for the determination of the times of flight,
wherein a first difference of the first time of flight and of a previously determined time of flight and/or a second difference of the second time of flight and of a previously determined second time of flight is/are calculated; and wherein if the first difference and/or the second difference amounts/amount to a multiple of the period of the carrier frequency, except for a tolerance, the first time of flight and/or the second time of flight is/are corrected by the multiple of the period of the carrier frequency.
